(19) United States
(12) Patent Application Publication
(10) Pub. No.: US 2026/0161915 A1
(43) Pub. Date: Jun. 11, 2026

(54) IMAGE PROCESSING APPARATUS AND PRINTING APPARATUS

(71) Applicant: KYOCERA Document Solutions Inc., Osaka (JP)

(72) Inventor: Kenichi HAYASHI, Osaka (JP)

(73) Assignee: KYOCERA Document Solutions Inc., Osaka (JP)

(21) Appl. No.: 19/401,074

(22) Filed: Nov. 25, 2025

(30) Foreign Application Priority Data
Dec. 5, 2024 (JP) 2024-212406

(51) Int. Cl. G06K 15/02; G06K 15/14

(52) U.S. Cl. CPC G06K 15/188; G06K 15/14

(57) ABSTRACT

An image processing apparatus includes a generating part, a specifying part and a correcting part. The generating part is configured to generate image data obtained by converting a reflected light from a document having an image of yellow colorant into a density. The specifying part is configured to specify a fluorescent region based on a first image data corresponding to a B channel among the generated image data. The correcting part is configured to correct the first image data in the fluorescent region using a second image data corresponding to a G channel or R channel among the generated image data.

### INCORPORATION BY REFERENCE

This application is based on and claims the benefit of priority from Japanese patent application No. 2024-212406, filed on Dec. 5, 2024, which is incorporated by reference in its entirety.

### BACKGROUND

The present disclosure relates to an image processing apparatus and a printing apparatus.

Copy paper (hereinafter referred to as paper) to which a fluorescent brightener is added is known. The fluorescent brightener absorbs ultraviolet light and emits pale blue visible light (fluorescence) with a wavelength of 400 to 450 nm. That is, the paper to which the fluorescent brightener is added emits fluorescence in addition to normal reflected light, so that the white areas of the paper appear whiter. The wavelength range of this fluorescence corresponds to the absorption spectrum of a yellow colorant.

### SUMMARY

An image processing apparatus according to the present disclosure includes a generating part, a specifying part and a correcting part. The generating part is configured to generate image data obtained by converting a reflected light from a document having an image of yellow colorant into a density. The specifying part is configured to specify a fluorescent region based on a first image data corresponding to a B channel among the generated image data. The correcting part is configured to correct the first image data in the fluorescent region using a second image data corresponding to a G channel or R channel among the generated image data.

A printing apparatus according to the present disclosure includes the image processing apparatus, an image forming device and a fixing device. The image forming device is configured to form a toner image with the density represented by the first image data corrected by the image processing apparatus. The fixing device is configured to fix the formed toner image on a sheet.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view showing an appearance of an image forming system according to one embodiment of the present disclosure.

FIG. 2 is a front view schematically showing configurations of a document conveying apparatus and a document reading apparatus according to the embodiment of the present disclosure.

FIG. 3 is a right side view schematically showing a configuration of a printing apparatus according to the embodiment of the present disclosure.

FIG. 4 is a block diagram showing a functional configuration of an image processing apparatus according to the embodiment of the present disclosure.

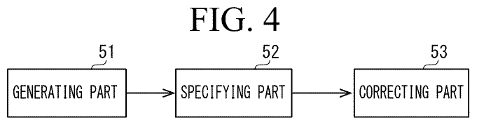

FIG. 5 is a flow diagram explaining a process executed by the image processing apparatus according to the embodiment of the present disclosure.

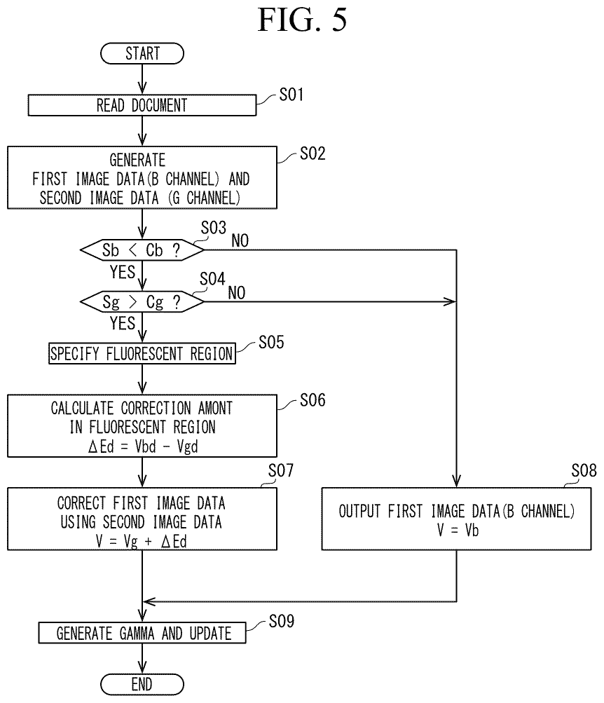

FIG. 6 is a diagram showing a relationship between an input value and a density according to the embodiment of the present disclosure.

FIG. 7 is a diagram showing a spectral reflectance of a paper containing no fluorescent brightener.

FIG. 8 is a diagram showing a spectral reflectance of a paper containing a fluorescent brightener.

FIG. 9 is a diagram showing a relationship between an input value and density in a conventional image reading apparatus.

### DETAILED DESCRIPTION

Hereinafter, with reference to the drawings, an image forming system 100 according to an embodiment of the present disclosure will be described.

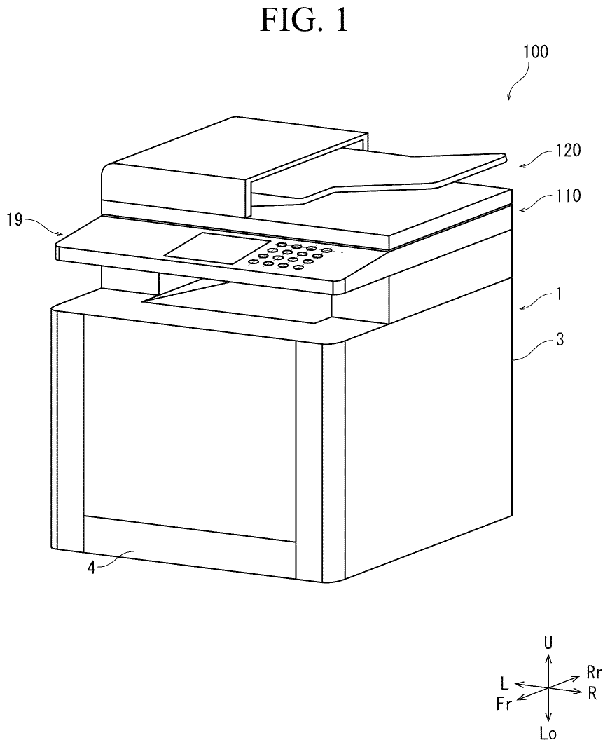

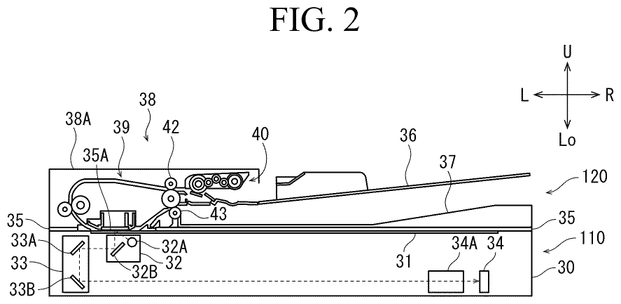

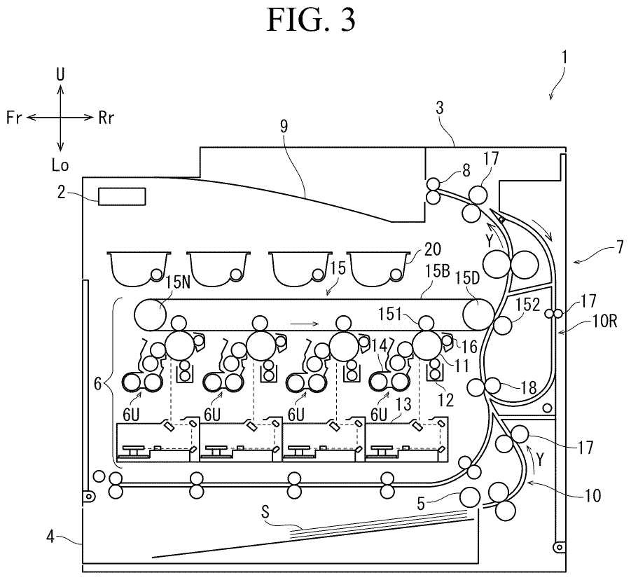

FIG. 1 is a perspective view showing an appearance of the image forming system 100. FIG. 2 is a front view schematically showing configurations of a document conveying apparatus 120 and a document reading apparatus 110. FIG. 3 is a right side view schematically showing a configuration of a printing apparatus 1. In each figure, U, Lo, L, R, Fr, and Rr indicate the upper, lower, left, right, front, and rear, respectively. These directions are merely established for the sake of explanation convenience.

The image forming system 100 (see FIG. 1) includes the printing apparatus 1, the document reading apparatus 110, and the document conveying apparatus 120. The document reading apparatus 110 is provided above the printing apparatus 1, and the document conveying apparatus 120 is provided above the document reading apparatus 110. The document conveying apparatus 120 conveys a document through a reading position of the document reading apparatus 110. The document reading apparatus 110 is a flatbed type image scanner and reads the document to generate image data. The printing apparatus 1 forms an image based on the image data on a sheet S.

[Printing Apparatus] The printing apparatus 1 (see FIG. 3) includes a rectangular parallelepiped main body housing 3. In the lower portion in the main body housing 3, a sheet feeding cassette 4 in which the sheet S is stored and a sheet feeding roller 5 which feeds the sheet S rearward from the sheet feeding cassette 4 are provided. Above the sheet feeding cassette 4, an image forming device 6 which forms a toner image in an electrophotographic manner is provided, and a fixing device 7 which fixes the toner image on the sheet S is provided on the rear and upper side of the image forming device 6. Above the fixing device 7, a discharge roller 8 which discharges the sheet S on which the toner image is fixed and a discharge tray 9 on which the discharged sheet S is loaded are provided.

Inside the main body housing 3, a conveying path 10 extending from the sheet feeding roller 5 to the discharge roller 8 through the image forming device 6 and the fixing device 7 is provided. The conveying path 10 is formed mainly of plate-like members facing each other with a gap for passing the sheet S, and a conveying roller 17 for holding and conveying the sheet S is provided at a plurality of positions in the conveying direction Y. A registration roller 18 is provided on the upstream side of the image forming device 6 in the conveying direction Y. An inversion conveying path 10R is provided on the right side of the fixing device 7. The inversion conveying path 10R branches from the conveying path 10 at a branch point located downstream of the fixing device 7 in the conveying direction Y and merges with the conveying path 10 at a merging point located upstream of the registration roller 18 in the conveying direction Y.

The image forming device 6 includes four sets of image forming units 6U and an intermediate transfer unit 15. The image forming unit 6U includes a photosensitive drum 11 whose potential changes by irradiation with light, a charging device 12 which charges the photosensitive drum 11, and an exposure device 13 which emits a laser beam corresponding to the image data. The image forming unit 6U further includes a developing device 14 which supplies toner to the photosensitive drum 11 and a cleaning device 16 which removes the toner remaining on the photosensitive drum 11. The intermediate transfer unit 15 includes an endless intermediate transfer belt 15B wound around a driving roller 15D and a driven roller 15N, a primary transfer roller 151 facing the inner peripheral surface of the intermediate transfer belt 15B at positions corresponding to the photosensitive drums 11 and generating a primary transfer bias, and a secondary transfer roller 152 facing the outer peripheral surface of the intermediate transfer belt 15B at a position corresponding to the driving roller 15D and generating a secondary transfer bias. A toner container 20 which replenishes the toner to the developing device 14 is connected to the developing device 14. The image forming device 6 forms a color image by superposing the toner images of four colors on the intermediate transfer belt 15B. The printing apparatus 1 may include two, three, or five or more image forming units 6U.

[Document Reading Apparatus] The document reading apparatus 110 (see FIG. 2) includes a rectangular parallelepiped housing 30, a first carriage 32 including a light source 32A and a reflecting mirror 32B, and a second carriage 33 including two reflecting mirrors 33A and 33B. The document reading apparatus 110 includes a lens 34A which focuses light to form an image, an imaging element 34 which converts the formed image into image data, and a contact glass 31 on which the document is placed. The contact glass 31 is provided on the upper surface of the housing 30.

[Document Conveying Apparatus] The document conveying apparatus 120 (see FIG. 2) includes a generally rectangular bottom plate 35 formed in a flat shape. The rear end portion of the bottom plate 35 is coupled to a rear portion of the contact glass 31 on the upper surface of the housing 30 via a hinge (not shown), and the bottom plate 35 is openable and closable around the hinge. The bottom plate 35 has a function of supporting each part of the document conveying apparatus 120 and a function of pressing the document on the contact glass 31.

The document conveying apparatus 120 includes a paper feeding tray 36, a conveying part 38, and a discharge tray 37. The bottom plate 35 has an opening 35A. The opening 35A is provided in a region facing the first carriage 32 positioned at the home position, and is formed into a rectangular shape elongated in the front-and-rear direction, and penetrates in the upper-and-lower direction. The conveying part 38 is covered with an outer cover 38A. A conveying path 39 extends leftward from the downstream side of the paper feeding tray 36 in the conveying direction Z, passes above the opening 35A via a conveying roller 42, curves downward, and reaches the discharge roller 43 via the opening 35A. A feeding part 40 (see FIG. 2) is provided on the inner surface (lower surface) of the upper right portion of the outer cover 38A.

[Control Part] A control part 2 includes an arithmetic part and a storage part (not shown). The arithmetic part is, for example, a CPU (Central Processing Unit). The storage part includes a storage medium such as ROM (Read Only Memory), RAM (Random Access Memory), and EEPROM (Electrically Erasable Programmable Read Only Memory). The arithmetic part reads and executes a control program stored in the storage part to perform various processes. The control part 2 may be implemented only by an integrated circuit without using software.

[Display Operation Part] A display operation part 19 is provided on the front side of the document reading apparatus 110. The display operation part 19 includes a display panel, a touch panel superposed on the display surface of the display panel, and a keypad. The control part 2 causes the display panel to display a screen showing an operation menu, a status, or the like of the printing apparatus 1 and the document reading apparatus 110, and controls each part of the printing apparatus 1 and the document reading apparatus 110 according to an operation detected by the touch panel and the keypad.

[Operation] The basic operation of the image forming system 100 is as follows. When a user places a document on the upper surface of the contact glass 31 and gives a reading instruction to the document reading apparatus 110, the second carriage 33 moves rightward at a speed V/2 in conjunction with the rightward movement of the first carriage 32 at a speed V. In the meantime, the light source 32A of the first carriage 32 irradiates the document with light, and the reflected light reflected by the document is reflected by the reflecting mirror 32B of the first carriage 32 and the reflecting mirrors 33A and 33B of the second carriage 33, guided to the lens 34A, focused to form an image on the imaging element 34, and the formed image is converted into an image signal. The image signal is output to the control part 2 of the printing apparatus 1 and converted into image data.

On the other hand, when the user places the document on the paper feeding tray 36 and gives a reading instruction to the document reading apparatus 110, the document is fed to the conveying path 39 one by one by the feeding part 40. The document is conveyed along the conveying path 39 and discharged to the discharge tray 37 via the opening 35A. During this time, the light source 32A of the first carriage 32 irradiates the document with light through the opening 35A. Then, the reflected light reflected by the document is reflected by the reflecting mirror 32B of the first carriage 32 and the reflecting mirrors 33A and 33B of the second carriage 33, is guided to the lens 34A, is focused to form an image on the imaging element 34, and the formed image is converted into an image signal. The image signal is output to the control part 2 of the printing apparatus 1 and converted into image data.

In the printing apparatus 1, the sheet feeding roller 5 feeds the sheet S from the sheet feeding cassette 4 to the conveying path 10, the registration roller 18 whose rotation is stopped corrects the posture of the sheet S, and the registration roller 18 feeds the sheet S to the image forming device 6 at a predetermined timing. In the image forming device 6, the charging device 12 charges the photosensitive drum 11 to a predetermined potential, and the exposure device 13 writes an electrostatic latent image on the photosensitive drum 11. Then, the developing device 14 forms a toner image by developing the electrostatic latent image using the toner replenished from the toner container 20, the primary transfer rollers 151 transfer the toner image to the intermediate transfer belt 15B, and the secondary transfer roller 152 transfers the toner image to the sheet S.

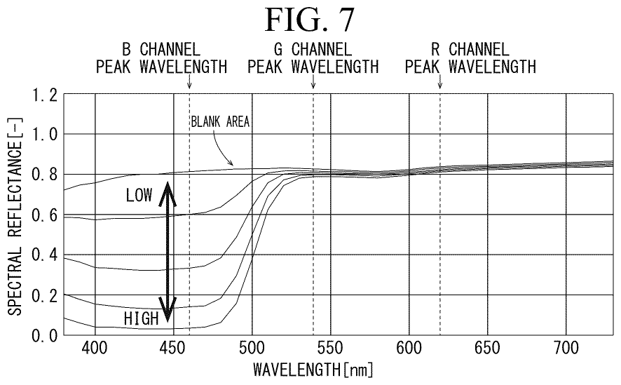

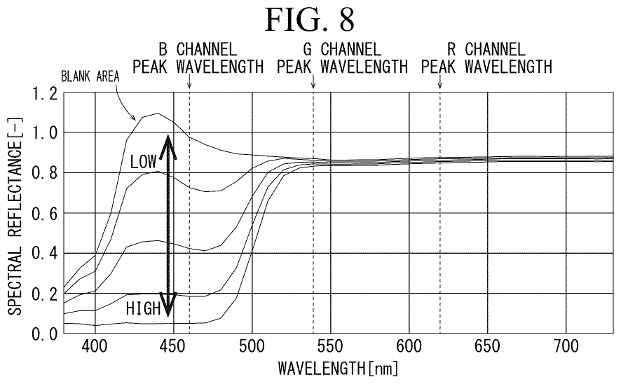

Subsequently, the fixing device 7 fuses the toner image while holding and conveying the sheet S to fix the toner image to the sheet S, and the discharge roller 8 discharges the sheet S to the discharge tray 9. In the case of double-sided printing, the sheet S having the toner image fixed on the first surface is fed to the conveying path 10 via the inversion conveying path 10R, and then the toner image is transferred to the second surface.

[Image Processing Apparatus] FIG. 7 is a diagram showing a spectral reflectance of a paper containing no fluorescent brightener. FIG. 8 is a diagram showing a spectral reflectance of a paper containing a fluorescent brightener. The horizontal axis represents wavelength [nm], and the vertical axis represents spectral reflectance (dimensionless). It shows a spectral reflectance when white light is irradiated to an image formed using yellow toner. An image density is represented in five levels, wherein the lowest density is a blank area where no toner is placed on the paper, and the highest density is a solid image where the paper is filled with the toner.

The phenomenon that the spectral reflectance decreases due to the absorption of the wavelength in the range of 400 to 500 nm by the yellow toner is common to the paper containing no fluorescent brightener and the paper containing the fluorescent brightener. However, in the case of the paper containing no fluorescent brightener (see FIG. 7), the spectral reflectance of the blank area in the wavelength range of 400 to 450 nm is about 0.8. On the other hand, in the paper containing the fluorescent brightener (see FIG. 8), as a result of adding fluorescence, a peak of spectral reflectance appears in the vicinity of 440 nm, and the peak value at the blank area is about 1.1. Therefore, when dots are formed at a low density on the paper containing the fluorescent brightener, since the spectral reflectance is only slightly reduced, the dots are not detected.

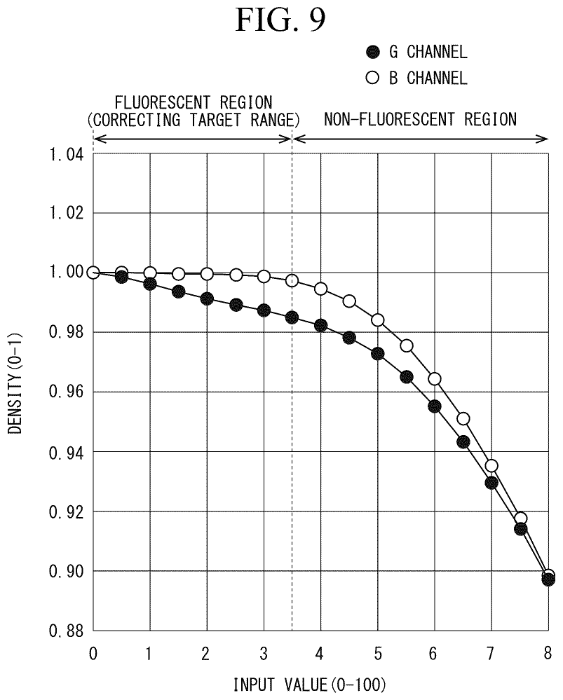

FIG. 9 is a diagram showing a relationship between an input value and a density in a conventional image reading apparatus. The input value (dimensionless) on the horizontal axis is a gray level value indicated by the image data. The density (dimensionless) on the vertical axis is the reciprocal of the spectral reflectance. The density was obtained from the spectral reflectance in the B channel (peak wavelength 460 nm) and the G channel (peak wavelength 540 nm) of the imaging element 34. In the G channel, since a density gradient appears in all regions of the input value, it is possible to reproduce the gradation even in a low density region. On the other hand, in the B channel, since the density gradient becomes flat in the low density region where the input value is about 3.5 or less, the gradation cannot be reproduced. Therefore, in the present embodiment, the gradation is improved by the following configuration.

First (step S01), the control part 2 reads the document by the document reading apparatus 110. Next (step S02), the control part 2 (a generating part 51) generates first image data Vb corresponding to the B channel of the imaging element 34 and second image data Vg corresponding to the G channel.

Next (step S03), the control part 2 determines whether or not there is a region where the density gradient Sb of the first image data Vb is less than the threshold Cb. When the density gradient Sb is less than the threshold Cb, it means that there exists a fluorescent region where the density in the B channel of FIG. 9 is flat. When there is a region where the density gradient Sb is less than the threshold Cb (step S03: YES), the control part 2 proceeds to step S04, and when there is no region where the density gradient Sb is less than the threshold Cb (step S03: NO), the control part 2 proceeds to step S08.

Next (step S04), the control part 2 determines whether or not the density gradient Sg of the second image data Vg is larger than the threshold Cg in the region where the density gradient Sb of the first image data Vb is less than the threshold Cb. The determination condition that the density gradient Sg is larger than the threshold Cg means that there is a significant density change. When the density gradient Sg is larger than the threshold Cg (step S04: YES), the control part 2 proceeds to step S05, and when the density gradient Sg is not larger than the threshold Cg (step S04: NO), the control part 2 proceeds to step S08.

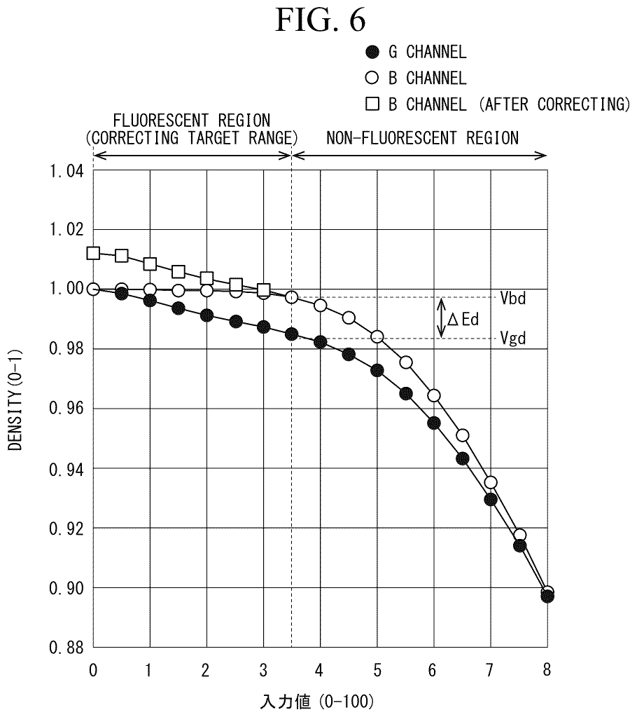

Next (step S05), the control part 2 (a specifying part 52) specifies the fluorescent region. Specifically, a range of input values (see FIG. 6) where the determination in step S03 is YES and the determination in step S04 is YES is specified as the fluorescent region. The fluorescent region is a correcting target range.

Next (step S06), the control part 2 (a correcting part 53) calculates a correction amount in the fluorescent region. Specifically, the control part 2 calculates a difference ΔEd between the first image data Vbd and the second image data Vgd at the boundary between the fluorescent region and the non-fluorescent region.

Next (step S07), the control part 2 (the correcting part 53) corrects the first image data Vb in the fluorescent region using the second image data Vg. Specifically, the control part 2 replaces the first image data Vb in the fluorescent region with a value obtained by adding ΔEd to the second image data Vg.

On the other hand, in step S08, since there is no fluorescent region, the control part 2 outputs the first image data Vb without correction.

Finally (step S09), the control part 2 generates gamma using the corrected first image data and updates.

The above-described image processing apparatus according to the present embodiment includes the generating part 51 configured to generate image data obtained by converting the reflected light from the document having an image of yellow colorant into a density. The image processing apparatus further includes the specifying part 52 configured to specify the fluorescent region based on the first image data corresponding to the B channel among the generated image data. The image processing apparatus further includes the correcting part 53 configured to correct the first image data in the fluorescent region using the second image data corresponding to the G channel or the R channel among the generated image data. According to this configuration, the image processing apparatus can improve gradation when reading the image formed on the paper containing a fluorescent brightener.

In the image processing apparatus according to the present embodiment, the correcting part 53 is configured to correct the first image data in the fluorescent region using the difference between the first image data Vbd and the second image data Vgd at the boundary between the fluorescent region and the non-fluorescent region. According to this configuration, it is possible to eliminate the level difference in density caused by the difference between the first image data and the second image data at the boundary between the fluorescent region and the non-fluorescent region.

In the image processing apparatus according to the present embodiment, the generating part 51 is configured to generate image data by normalizing the density within the range including the blank area and the solid image area. According to this configuration, it is possible to avoid the influence of variations in RGB values depending on the paper.

Although the disclosure has been described for specific embodiments, the disclosure is not limited to the foregoing embodiments. The above embodiments can be modified by those skilled in the art without departing from the scope and spirit of the present disclosure.

1. An image processing apparatus, comprising:
a generating part configured to generate image data obtained by converting a reflected light from a document having an image of yellow colorant into a density;
a specifying part configured to specify a fluorescent region based on a first image data corresponding to a B channel among the generated image data; and
a correcting part configured to correct the first image data in the fluorescent region using a second image data corresponding to a G channel or R channel among the generated image data.

2. The image processing apparatus according to Claim 1, wherein
the correcting part is configured to correct the first image data in the fluorescent region using a difference between the first image data and the second image data at a boundary between the fluorescent region and a non-fluorescent region.

3. The image processing apparatus according to Claim 1, wherein
the generating part is configured to generate the image data by normalizing a density within a range including a blank area and a solid image area.

4. The image processing apparatus according to Claim 1, wherein
the document contains a fluorescent brightener emitting fluorescence,
a wavelength of absorption light absorbed by the yellow colorant corresponds to a wavelength of the fluorescence,
the B channel, the G channel and the R channel are channels of an imaging element, and
a peak wavelength of the B-channel is closer to the wavelength of the absorption light than a peak wavelength of the G-channel or the R-channel.

5. A printing apparatus comprising:
the image processing apparatus according to claim 1;
an image forming device configured to form a toner image with the density represented by the first image data corrected by the image processing apparatus; and
a fixing device configured to fix the formed toner image on a sheet.
